(19) United States
(12) Patent Application Publication
(10) Pub. No.: US 2009/0030660 A1
(43) Pub. Date: Jan. 29, 2009

(54) METHOD AND APPARATUS FOR GENERATING FULLY DETAILED THREE-DIMENSIONAL ELECTRONIC PACKAGE AND PCB BOARD MODELS

(75) Inventors: Zeki Celik, Sunnyvale, CA (US); Atila Mertol, Cupertino, CA (US)

Correspondence Address: Henry Groth;LSI Logic Corporation, MS D-106, 1621 Barber Lane, Milpitas, CA, 95035, US

(73) Assignee: LSI Logic Corporation, Milpitas, CA (US)

(21) Appl. No.: 11/782,393

(22) Filed: Jul. 24, 2007

(51) Int. Cl. G06F 17/10

(52) U.S. Cl. 703/2

(57) ABSTRACT

A process is provided, which includes receiving geometrical information for a plurality of layers of an electronic structure within at least one output data file from an electronic structure design tool. At least one numerical analysis data file is created from the output data file, which contains the geometrical information and has a file structure compatible with a numerical analysis tool for characterizing the electronic structure. The numerical analysis tool is used to read the numerical analysis data file and generate a three-dimensional meshed geometric model of the electronic structure from the numerical analysis data file, wherein the model includes three-dimensional geometric models of each layer. The model can then be used, for example, to solve numerical thermal, mechanical or electrical equations that are applied to the model.

### CROSS-REFERENCE TO RELATED APPLICATION

None.

### FIELD OF THE DISCLOSURE

The present disclosure relates to generation of models for electronic packages and/or printed circuit boards. More particularly, the present disclosure relates to a method and apparatus for generating fully detailed three-dimensional models for use in numerical analysis tools, such as for simulating or otherwise analyzing thermal, mechanical and/or electrical characteristics, for example.

### BACKGROUND

Semiconductor integrated circuits and other electronic devices are typically housed in a package that is mounted to a printed circuit board for interconnection with other electronic circuits and devices.

As electronic system performance requirements continue to increase, these systems must dissipate an increasing amount of electrical power. Increasing power dissipation requirements have therefore become a great challenge for thermal and circuit design engineers. Although heat sinks can be effective in dissipating heat, in order to lower the system cost, heat sinks are avoided if possible. By doing so, more emphasis is put on the thermal interaction between the package and the board. A measure that is used to characterize thermal characteristics of electronic packages is junction-to-board thermal resistance, which depends strongly on the package's internal design.

Variations in structural features such as the solder mask layer openings, individual package vias and locations, package trace locations and distributions in trace layers significantly affect thermal performance of the package. Desired changes in thermal performance can therefore be accomplished by modifying the package layers with various design options, such as use of different solder mask openings under the die, different power and ground plane thicknesses, and different via filling materials, as well as by modifying construction of the package top, e.g., the use of a mold and heat spreader. In order to quantify the individual effects of each design option, information is needed regarding the internal design of the package.

One existing method of measuring these effects is to create a simplified electronic package model. For example, a model can be created by generating individual rectangular volumes and assigning each volume with particular thermal properties. However, the creation of such models is extremely tedious due to the difficulty of generating the details of the models. These models are therefore extremely simplified. As a result, the existing simplified models do not accurately represent the internal details of the package being modeled. All design variations therefore cannot be explored, and thermal effects cannot be quantified separately. Thus, it becomes difficult to answer “what if” kinds of questions since detailed package information is not available.

Another existing method of measuring the effects of various design options on thermal performance is to assemble and measure a selected group of electronic packages having different design options. However, it may not be possible to measure the effects of all design options since this is often too costly and time consuming.

Improved methods and apparatus are therefore desired for modeling electronic packages that enable quantification of thermal improvement due to variations in package design parameters. A method and apparatus are also desired for reducing the package design cycle time and cost necessary to provide thermally enhanced packages.

### SUMMARY

An aspect of the present disclosure relates to a process, which includes: (a) receiving geometrical information for a plurality of layers of an electronic structure within at least one output data file from an electronic structure design tool; (b) creating at least one numerical analysis data file from the output data file, which contains the geometrical information and has a file structure compatible with a numerical analysis tool for characterizing the electronic structure; (c) reading the numerical analysis data file with the numerical analysis tool and using the numerical analysis tool to generate a three-dimensional meshed geometric model of the electronic structure from the numerical analysis data file, wherein the model comprises three-dimensional geometric models of each layer; and (d) at least temporarily storing the geometric model of the electronic structure on a computer-readable medium.

Another aspect of the present disclosure relates to a process, which includes: (a) storing all two-dimensional geometric information for a plurality of layers of an electronic structure within at least one output data file, from an electronic structure design tool; (b) creating at least one numerical analysis data file containing the geometrical information, which has a file structure compatible with a numerical analysis tool for characterizing the electronic structure; (c) reading the numerical analysis data file with the numerical analysis tool and using the numerical analysis tool to generate a three-dimensional geometric model of the electronic structure containing all of the two-dimensional geometric information, wherein the model contains a three-dimensional representation of each layer; and (d) at least temporarily storing the geometric model of the electronic structure on a computer-readable medium.

Another aspect of the present disclosure relates to a computer-readable medium containing instructions recorded thereon, which when executed by a computing device perform a process as described above.

### BRIEF DESCRIPTION OF THE DRAWINGS

FIG. 1 is a flowchart, which illustrates a process of generating a geometric model of an electronic structure according to an illustrative aspect of the present disclosure.

FIGS. 2A-2I illustrate one-eighth sections of geometrical information represented in models of respective layers of an electronic package substrate from bottom to top, according to an illustrative aspect of the present disclosure.

FIGS. 3A-3I illustrate one-eighth sections of geometrical information represented in models of respective layers of a printed circuit board from bottom to top, according to an illustrative aspect of the present disclosure.

FIG. 4 illustrates a model of an assembled electronic package, according to an illustrative aspect of the present disclosure.

FIG. 5 illustrates a one-eighth section of an assembled model of the electronic package as attached to a printed circuit board, according to an illustrative aspect of the present disclosure.

FIG. 6 is a diagram illustrating an example of a geometric model of board and package internal metal features and solder ball interconnect according to an example of the present disclosure.

### DETAILED DESCRIPTION OF ILLUSTRATIVE EMBODIMENTS

An exemplary aspect of the present disclosure relates to a method and apparatus for generating a fully-detailed model of an electronic package that may be used with a numerical analysis tool for characterizing physical properties such as thermal, electrical, and mechanical properties and computational fluid dynamics (CFD). For example, the model can be used to quantify thermal improvements due to variations in package design parameters. Such a model can be used to reduce package design cycle time and cost associated with providing thermally enhanced packages. In one exemplary aspect of the disclosure a method and apparatus are provided for generating a numerical model that incorporates all geometric details of a package construction as designed to enable numerical analysis using a numerical analysis tool.

In the example provided below, the method translates package details of a Ball Grid Array (BGA) package) from a Cadence APD data file generated from a Cadence Allegro Package Design software tool (available from Cadence Design Systems) to a file structure that is compatible with an ANSYS finite element analysis tool (available from Ansys, Inc.). Using the ANSYS Parametric Design Language (APDL) and the geometric information included in the translated data file, a parametric detailed model of the BGA package is created without assumptions or simplifications, for example. In the following example, the detailed package model has the following features:

(i) includes all details of the package geometry;

(ii) is fully parametric to enable changes to the package geometry;

(iii) is modular, i.e., includes separate modules for via generation, traces, etc...;

(iv) is able to read data files that were generated using the package design software, e.g., Cadence APD files; and

(v) includes a detailed test board, which is also generated using the Cadence APD files.

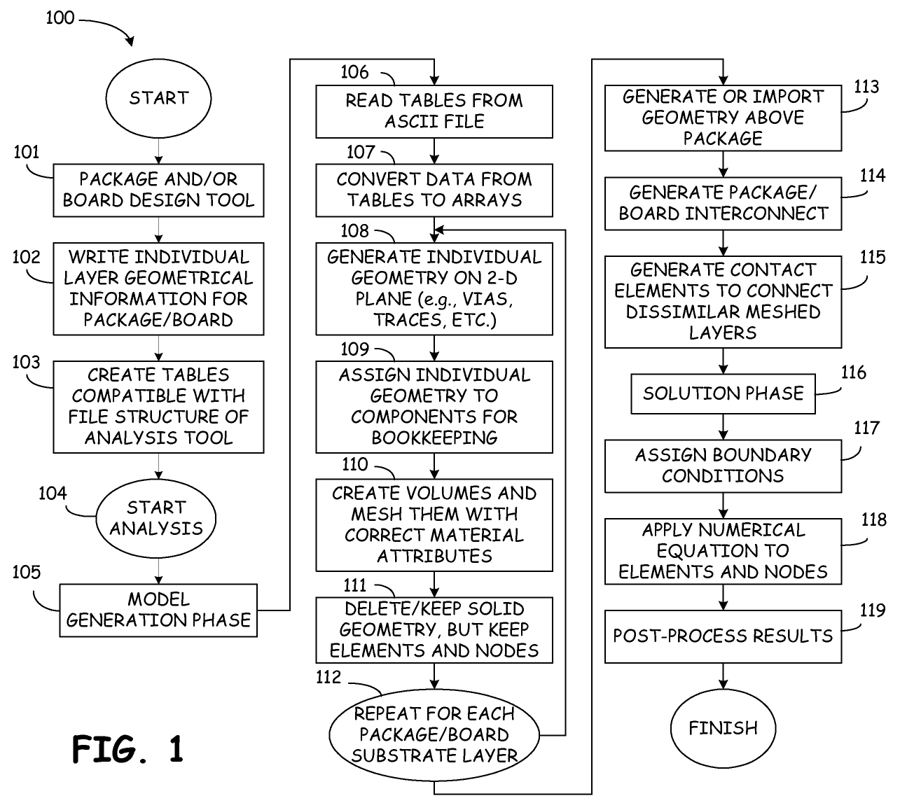

FIG. 1 is a flowchart illustrating a process 100 for generating a fully-detailed finite element model of an electronic structure, such as an electronic package and/or a printed circuit board (PCB), according to an illustrative aspect of the present disclosure. Process 100 develops the model in two stages. In the first stage, beginning at step 101, geometric information for the electronic structure is extracted from the design tool that was used to design the structure. For example, for an electronic package that was designed using the Allegro Package Designer software tool, the design tool is used to write geometrical information for individual layers of the package substrate and/or circuit board into at least one Cadence APD (or other file structure) output data file, at step 102. In one example, all geometric information for all layers in the electronic substrate or circuit board is written to the APD file(s). Other output file formats can also be used.

At step 103, process 100 translates the geometric information contained in the output data file to a file structure that is compatible with a numerical analysis tool for characterization of one or more physical properties, such as thermal, electrical, mechanical and/or fluidic properties. In an illustrative example, process 100 transfers the geometric information into one or more tables having a format, such as an ASCII file format, that is compatible with the ANSYS APDL language. For example, the geometric information for each layer of the electronic structure can be transferred into a respective table for that layer. Other file structures and data formats can be used in alternative examples.

In one illustrative example, each table created in step 103 includes all of the two-dimensional geometric information for a particular layer in the electronic structure. Since the tables are created from the package (or and/or board) design software tool, no assumptions are made regarding the package or board, and no geometrical simplifications are necessary. All of the geometrical information for each layer is contained in the tables in step 103.

In the second stage of the process 100, beginning at step 104, a parametric detailed model of the electronic structure is generated using the geometrical information contained in the tables created in step 103. For example, the model can be generated using instructions written in the language interface of the numerical analysis tool with which numerical analysis of the model will be performed. A typical numerical analysis tool includes a pre-processor module for generating models to be simulated or otherwise analyzed. The pre-processor module can be programmed or operated to access and execute the model generation instructions, which can be recorded on a computer-readable medium. In this particular example, the model generation instructions are written in the ANSYS APDL language.

At step 104, the ANSYS finite element analysis tool (or another numerical analysis tool) is started, and model generation begins at step 105. The pre-processor module of the ANSYS tool calls the model generation instructions, which read the geometrical information into the tool from the external tables created in step 103.

At step 107, process 100 converts the geometrical information from each table to a two-dimensional array, for example. The data for individual layers are used to generate two-dimensional footprints for the geometry of each layer, which include all of the layer attributes, such as locations of vias, via plating, individual traces, etc. along x and y axes, for example, as shown in step 108.

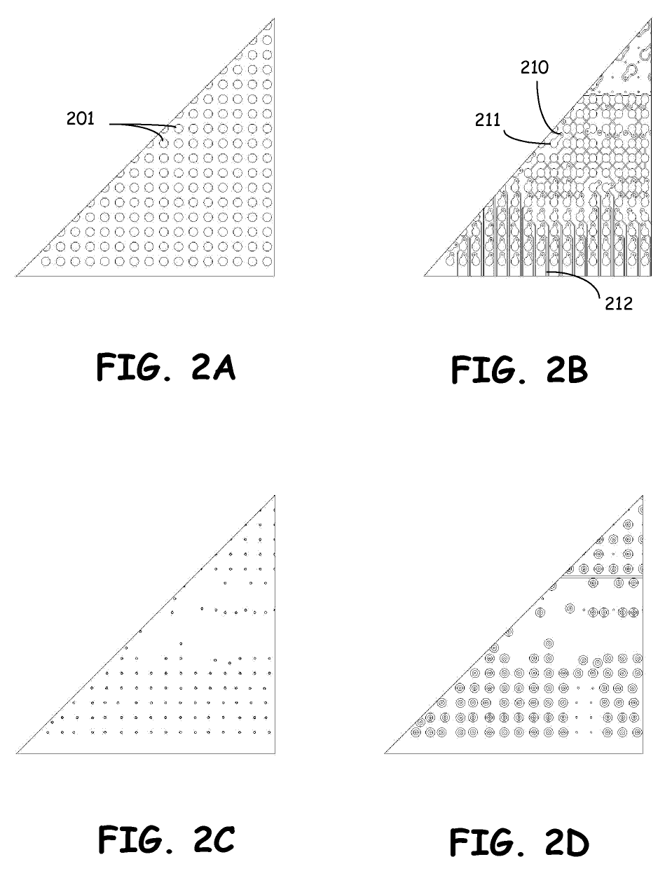

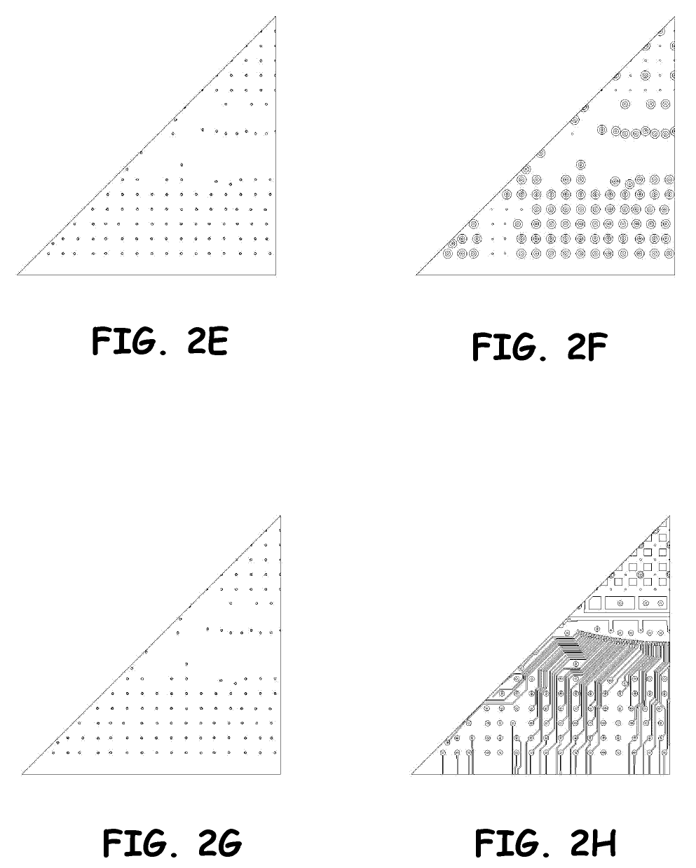

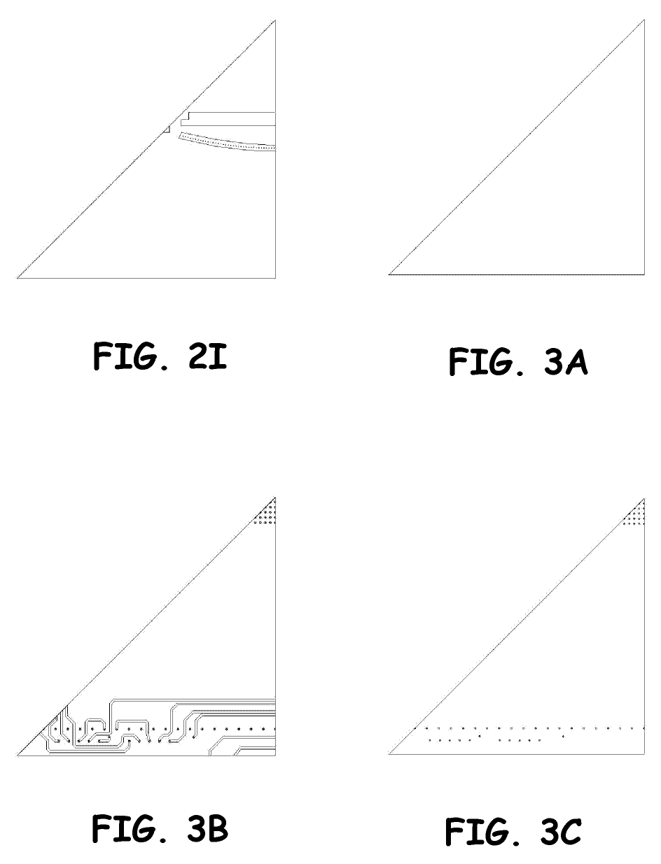

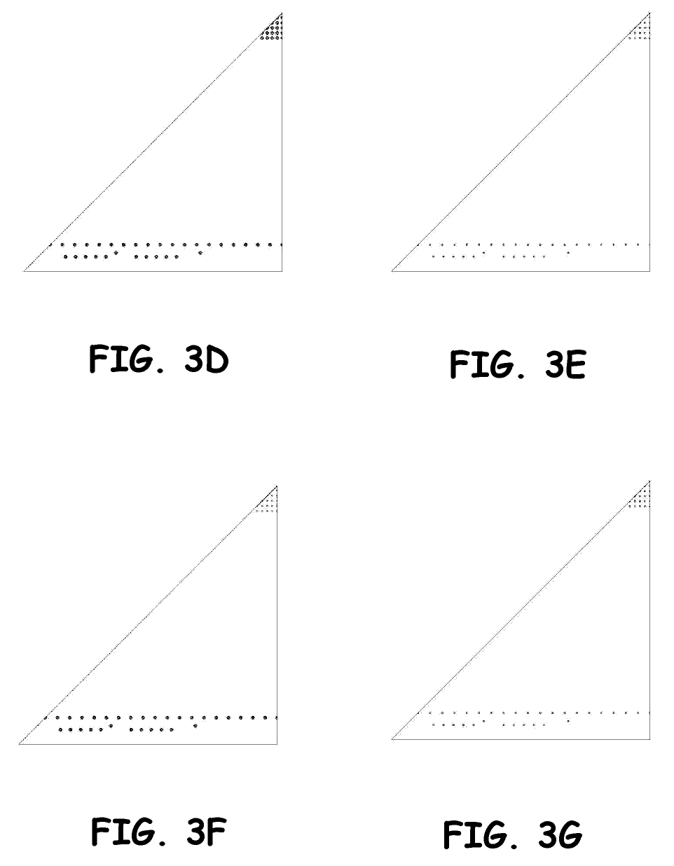

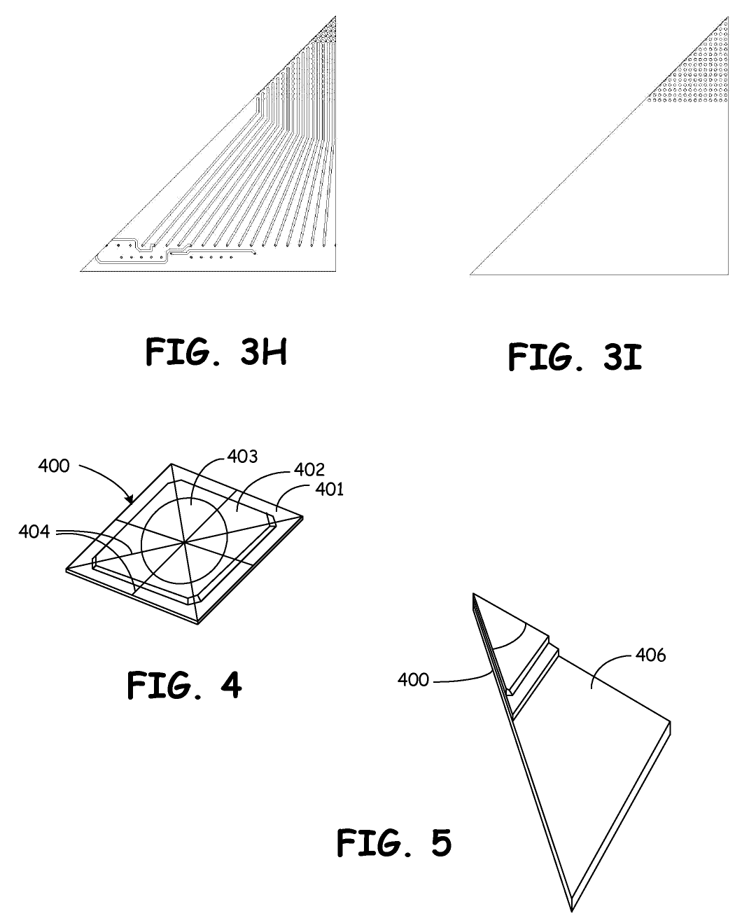

FIGS. 2 and 3 illustrate examples of two-dimensional geometrical information that can be contained in each array, for various layers of an electronic structure.

FIGS. 2A-2I illustrate geometrical information for each layer of an illustrative BGA electronic package substrate. Each figure illustrates a one-eighth section of the respective layer. FIG. 2A illustrates a package bottom solder mask, FIG. 2B illustrates a package bottom signal layer, FIG. 2C illustrates a package bottom dielectric layer, FIG. 2D illustrates a package power plane layer, FIG. 2E illustrates a package core dielectric layer, FIG. 2F illustrates a package ground plane layer, FIG. 2G illustrates a package top dielectric layer, FIG. 2H illustrates a package top signal layer, and FIG. 2I illustrates a package top solder mask layer. Any number of suitable layers can be used in alternative embodiments, and each layer can have any suitable geometry.

Similarly, FIGS. 3A-3I illustrate exemplary geometrical information for one-eighth sections of the various layers of a printed circuit board. FIG. 3a illustrates a board bottom solder mask layer, FIG. 3B illustrates a board bottom signal layer, FIG. 3C illustrates a board bottom dielectric layer, FIG. 3D illustrates a board power plane layer, FIG. 3E illustrates a board core dielectric layer, FIG. 3F illustrates a board ground plane layer, FIG. 3G illustrates a board top dielectric layer, FIG. 3H illustrates a board top signal layer, and FIG. 3I illustrates a board top solder mask layer.

Referring to FIG. 2A, for example, the geometrically information for the package bottom solder mask layer includes x,y locations of each of a plurality of solder balls 201. For each solder ball 201, the geometric information represents the geometric location of the center of the solder ball along an x-axis and a y-axis. Each solder ball has a known radius. Referring to FIG. 2B, the package bottom signal layer includes a plurality of features, such as a plurality of vias 210, via pads 211 and conductive traces 212. The geometrical information includes the location of each via and via pad, the geometrical center of each conductive trace and the length of each trace along the x and/or y-axis, such as by specifying a start point and an end point. For example, each trace can be represented by a plurality of segments of a known length. Interconnections of vias, via pads and conductive trace segments can be determined from intersections of the geometrical information. The geometrical information for each attribute can be represented in any suitable manner.

Referring back to FIG. 1, the geometrical information of each layer shown in FIGS. 2A-2I and 3A-3I is transferred to a respective array, in step 107. Beginning at step 108, the two-dimensional information in each layer is then processed to create a three-dimensional geometric model for that layer. For convenience, the two-dimensional information for each layer is processed separately. However, all layers can be processed together in alternative embodiments, for example. At step 108, for each layer process 100 generates individual geometry for that layer on a two-dimensional plane. This geometry reflects the geometric locations of the features shown in FIGS. 2A-2I and 3A-3I, for example. In the example shown in FIG. 2B, the array for the package bottom signal layer will include the x and y locations of each via 210 and an indication of the layer on which the via resides.

At step 109, process 100 assigns individual geometry to components of each layer. Process 100 groups areas with specific attributes (e.g., vias, via plating, individual traces, etc.). For example, all vias are grouped as a via component, and all traces are grouped as a trace component. However, geometric areas having specific attributes can be organized in smaller groups or grouped individually, such by as grouping each via or trace as a separate component, for example. By grouping all vias (or traces, etc.) as a grouped component, these components can be conveniently modeled as a single component for purposes of analyzing thermal, mechanical, electrical or other physical properties.

At step 110, the process chooses individual groups and extrudes them separately in the z-direction to create three-dimensional components, such as vias, traces, etc. and assigns each volumetric component with the correct material attribute. For each volumetric component, process 100 creates a mesh for that group. The mesh is formed of a plurality of finite elements and nodes. Each element corresponds to a small rectangular volume of the component in the x, y and z directions. The corners of the volumes represent the nodes of the mesh.

Process 100 can be adapted to create a mesh for the entire layer, where the elements and nodes corresponding to a particular group are assigned the attributes for that group (e.g., the elements corresponding to the trace group being assigned a conductive material property); and/or process 100 can generate a separate mesh for each group to enable creation of finer a mesh in one group and coarser mesh in another one, for example. Other variations are also possible.

The finite elements corresponding to conductive traces are assigned a corresponding material trace property, such as a conductive property, whereas the finite elements corresponding to dielectric material are assigned a dielectric material property. Interconnections of finite elements having the same attributes can be determined by the coincidence of the corners of each element.

At step 111, process 100 can be adapted to delete or keep the solid geometry of the array, while retaining information defining the elements and nodes. Deleting the solid geometry reduces the file size while retaining all of the geometric information for the layer. When the solid geometry is deleted, numerical simulations performed on the resulting model are solved using the elements and nodes. If the solid geometry is kept, the file size may get bigger and it may increase the simulation time due to the access to the large file.

At step 112, steps 108 through 111 are repeated for each layer of the package and/or PCB board being modeled.

At step 113, process 100 generates or imports a volumetric model of the geometry above the package substrate. The model of any layers or materials above the package substrate can be created to reflect a variety of different package assembly options and methodologies. For example, the model can reflect different sizes of die attached to the substrate and the use of a mold and/or heat spreader. By using different assembly options, the model can be used to analyze different package constructions, such as a molded flip-chip package, a bare die flip-chip package, a package with a stiffener only, etc. Therefore, depending on the package options and the die size, the model of the layers above the package substrate can provide geometric information for these layers to the numerical analysis tool for analysis.

The geometry above the package substrate can be created or imported by the pre-processing module of the numerical analysis tool before, after or during creation of the models for the package substrate layers.

Similarly, at step 114, a geometric three-dimensional model of the interconnect between the package and the PCB board can be created or imported by the pre-processing module, for example. For example, the interconnect model can include individual volumes for solder balls, columns or leads having the appropriate material properties.

At step 115, process 100 generates contact elements, which connect mesh elements between adjacent meshed layers. The elements and nodes of one layer may not perfectly align with corresponding elements of the next, adjacent layer. To eliminate a thermal (or other material property) discontinuity between layers within the overall model, the contact elements between the finite elements of dissimilarly meshed layers are assigned a higher thermal conductivity, for example, to ensure that the resulting model will conduct heat (or other property such as stress) between elements of adjacent layers.

FIG. 4 is a diagram illustrating an example of a resulting three-dimensional package model 400 in which the 3-D models for the various layers of the package substrate 401 are assembled with a mold 402 and a heat spreader 403 to form an overall geometric model of the package. An electronic die (not shown) is enclosed within mold 402. Diagonal lines 404 represent divisions between the one-eighth sections of each layer shown in FIGS. 2A-2I and 3A-3I.

FIG. 5 illustrates a one-eighth finite element model of the package and board assembly, where the board is represented by reference numeral 406.

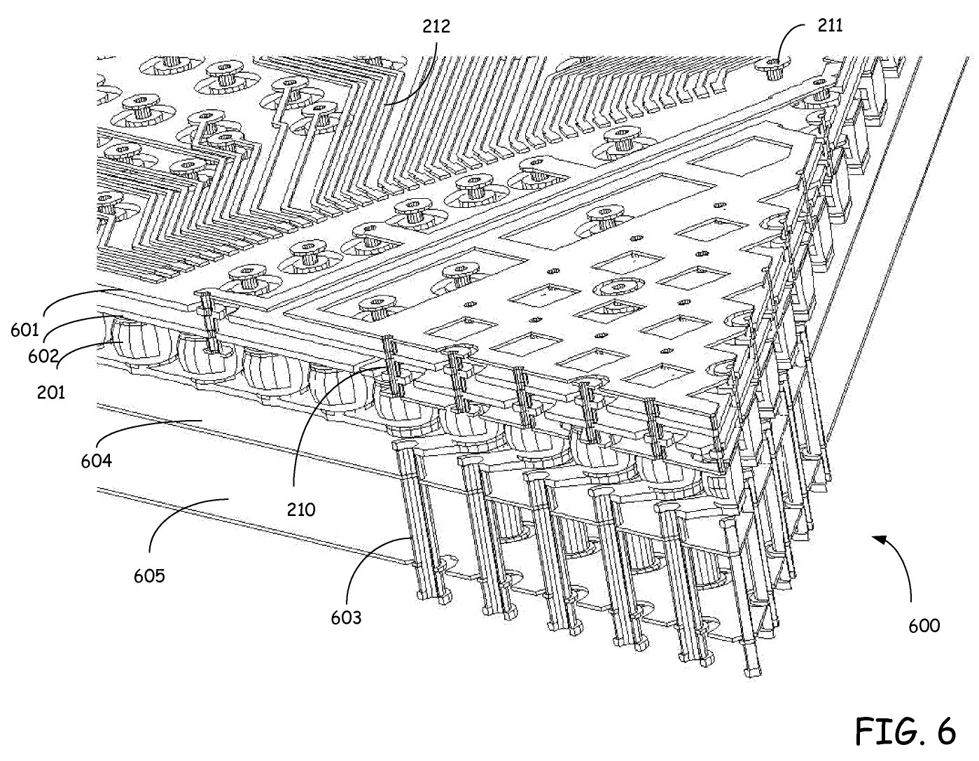

FIG. 6 is a fragmentary, perspective view of the various metal layers 600 in the model shown in FIGS. 4-5. These metal layers correspond to the modeled metal layers shown in FIGS. 2-3, for example. In this illustrative example, the three-dimensional model contains all of the geometrical information for each layer of the board and package, such as package vias 210, package via pads 211, conductive traces 212, package ground plane 601, package power plane 602, board vias 603, board ground plane 604 and board power plane 605. These layers can have any order in alternative embodiments, and the model can include all or part of any particular layer and can include all layers or only a subset of the layers.

Step 116 represents the start of a solution phase for analyzing the resulting numerical geometric model of the electronic structure (e.g., electronic package and/or PCB board). Typical numerical analysis tools have a solution module with which thermal, mechanical, electrical, CFD and coupled physical simulations, for example, can be performed on each meshed element and the nodes attached to the meshed elements.

At step 117, process 100 assigns boundary conditions to the models, such as assigning power to the die, ambient temperature, heat transfer coefficients, etc., depending on the physical phenomena studied.

At step 118, the solution module applies numerical equations to the model and solves for physical characteristics, such as thermal resistance attributes of the package and/or board.

At step 119, a post-processing module of the numerical analysis tool can be used to process the results of the numerical solutions generated in step 118. For example, the solution data on elements and nodes can be used to generate contour and/or other kinds of graphics for analysis and interpretation of the results.

Process 100 therefore generates a numerical geometric model of the package and/or board details as shown in FIGS. 2 and 3. Using process 100, model generation may take significantly less time (days/months) as compared to prior methods. Actual package details can be modeled as designed by the package design software.

If desired, an exact replica of the electronic package as designed can be created for numerical analysis. Since the model includes all geometrical information regarding the package and/or board design, the model can be used to easily explore numerous “what if” conditions and resulting effects on thermal and/or other physical characteristics. Each design variation can easily be quantified in terms of thermal values. For example, all vias in the package may be separately represented in the model and grouped as a “via group”. Therefore, the effect of via attributes can be studied by changing the material attributes of the via group or by shutting off some vias by assigning dielectric properties to those vias, for example. These “what if” conditions can be modeled and simulated without making any simplifications of the package and/or board geometries.

One exemplary aspect of the present disclosure of directed to a process such as that described above. Another aspect of the disclosure is directed to a computer-readable medium containing instructions recorded thereon, which when executed by a computing device perform all or any part of a process such as that described above.

In general, one or more of the steps of process 100 shown in FIG. 1 can be implemented as part of an operating system or a specific application, design or analysis tool, database, component, program, object, module or sequence of instructions, for example. The elements typically comprise one or more instructions or databases that are resident at various times in various memory and storage devices in or associated with a computing device, and that, when read and executed by one or more processors in a computer network, cause that computer or computers to perform the instructions and/or process the databases embodying the various aspects of the disclosure. Examples of computer readable media on which such instructions and/or databases can be stored include but are not limited to recordable type media such as volatile and nonvolatile memory devices, floppy and other removable disks, hard disk drives, optical disks, e.g., CD-ROMs, DVDs, etc., among others.

Although the present disclosure has been described with reference to one or more illustrative examples, workers skilled in the art will recognize that changes may be made in form and detail without departing from the scope of the disclosure and/or the appended claims.

What is claimed is:

1. A process comprising:
(a) receiving geometrical information for a plurality of layers of an electronic structure within at least one output data file from an electronic structure design tool;
(b) creating at least one numerical analysis data file from the output data file, which contains the geometrical information and has a file structure compatible with a numerical analysis tool for characterizing the electronic structure;
(c) reading the numerical analysis data file with the numerical analysis tool and using the numerical analysis tool to generate a three-dimensional meshed geometric model of the electronic structure from the numerical analysis data file, wherein the model comprises three-dimensional geometric models of each layer; and
(d) at least temporarily storing the geometric model of the electronic structure on a computer-readable medium.

2. The process of claim 1 wherein the electronic structure comprises at least one of an electronic package or a printed circuit board.

3. The process of claim 1 and further comprising writing the geometrical information to the at least one output data file using the electronic structure design tool.

4. The process of claim 1, wherein step (a) comprises:
receiving all two-dimensional geometric information for each of the plurality of layers within the at least one output data file.

5. The process of claim 1, wherein step (b) comprises:
transferring the geometrical information from the at least one output data file to at least one table, which has a file structure compatible with the numerical analysis tool.

6. The process of claim 1, wherein step (c) further comprises, for each layer:
creating an array for that layer, wherein the array contains the two-dimensional geometric information and material attributes for components of the layer;
grouping together areas of the layer with specific material attributes to form at least one group;
extruding the at least one group in a third dimension to form at least one volume; and
generating a mesh from the at least one volume, which comprises a plurality of volumetric elements and nodes at corners of the elements.

7. The process of claim 6, wherein step (c) further comprises:
deleting solid geometry between the nodes while retaining the volumetric elements and nodes.

8. The process of claim 6, wherein step (c) further comprises:
generating the three-dimensional meshed geometric model of the electronic structure from the meshes of the plurality of layers.

9. The process of claim 6 and further comprising connecting together the mesh elements of corresponding components in adjacent layers, which have the specific material attributes.

10. A process comprising:
(a) storing all two-dimensional geometric information for a plurality of layers of an electronic structure within at least one output data file, from an electronic structure design tool;
(b) creating at least one numerical analysis data file containing the geometrical information, which has a file structure compatible with a numerical analysis tool for characterizing the electronic structure;
(c) reading the numerical analysis data file with the numerical analysis tool and using the numerical analysis tool to generate a three-dimensional geometric model of the electronic structure containing all of the two-dimensional geometric information, wherein the model contains a three-dimensional representation of each layer; and
(d) at least temporarily storing the geometric model of the electronic structure on a computer-readable medium.

11. The process of claim 10, wherein the electronic structure comprises at least one of an electronic package or a printed circuit board.

12. The process of claim 10, wherein step (b) comprises:
transferring the geometrical information from the at least one output data file to at least one table, which has a file structure compatible with the numerical analysis tool.

13. The process of claim 10, wherein step (c) further comprises, for each layer:
creating an array for that layer, wherein the array contains the two-dimensional geometric information and contains material attributes for components of the layer;
grouping together areas of the layer with specific material attributes to form at least one group;
extruding the at least one group in a third dimension to form at least one volume; and
generating a mesh from the at least one volume, which comprises a plurality of volumetric elements and nodes at corners of the elements.

14. The process of claim 13, wherein step (c) further comprises:
deleting solid geometry between the nodes while retaining the volumetric elements and nodes.

15. The process of claim 13, wherein step (c) further comprises:
retaining solid geometry between the nodes within the geometric model stored in step (d).

16. The process of claim 13, wherein step (c) further comprises:
generating the three-dimensional geometric model of the electronic structure from the meshes of the plurality of layers.

17. The process of claim 13 and further comprising connecting together the mesh elements of corresponding components in adjacent layers, which have the specific material attributes.

18. A computer-readable medium containing instructions recorded thereon, which when executed by a computing device perform a process comprising:
(a) receiving geometrical information for a plurality of layers of an electronic structure within at least one output data file from an electronic structure design tool;
(b) creating at least one numerical analysis data file from the output data file, which contains the geometrical information and has a file structure compatible with a numerical analysis tool for characterizing the electronic structure;
(c) reading the numerical analysis data file with the numerical analysis tool and using the numerical analysis tool to generate a three-dimensional meshed geometric model of the electronic structure from the numerical analysis data file, wherein the model comprises three-dimensional geometric models of each layer; and
(d) at least temporarily storing the geometric model of the electronic structure on a computer-readable medium.
